(19) United States
(12) Patent Application Publication
(10) Pub. No.: US 2004/0041292 A1
(43) Pub. Date: Mar. 4, 2004

(54) Method and device for making shoe sole having gradually changed color

(76) Inventors: Ching-Chin Chen, Taichung (TW); Shih-Kan Liang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/232,420

(22) Filed: Sep. 3, 2002

(51) Int. Cl. B29C 44/02

(52) U.S. Cl. 264/45.4

(57) ABSTRACT

A method and a device for making a shoe sole includes step 1: treating Ethylene Vinyl Acetate (EVA) into particles; step 2: sorting the particles into multiple piles and mixing the piles of particles with color agents to form multiple piles of mixtures from light color to dark color; step 3: putting the multiple piles of mixtures into respective cavities in a dispenser, and step 4: putting the multiples of material into a shoe mold and foaming the material under certain temperature to form a shoe sole.

### FIELD OF THE INVENTION

The present invention relates to a method and device for making a shoe sole made of Ethylene Vinyl Acetate (EVA) and the shoe sole has a color changes gradually from light to dark.

### BACKGROUND OF THE INVENTION

A conventional shoe sole made of Ethylene Vinyl Acetate (EVA) has only one color which is not attracted by the customers so that the manufacturers try to have more colors or to make a shoe sole that is colorful. One of the conventional ways to make the shoe sole to have more colors is to spread colors onto the sole that has only one color. The spread colors cannot last long on the shoe sole. Another conventional way is to connect a plastic plate to the shoe sole and the plastic plate has a color that is different from the color of the shoe sole. This increase the processes for making the shoe sole and the plastic plate affects the flexibility of the shoe sole.

The present invention intends to provide a method that uses several piles of material from light color to dark color and then put into a shoe mold to make a shoe sole which has a gradually changed color.

### SUMMARY OF THE INVENTION

The present invention relates to a method and a device for making a shoe sole, wherein the method includes step 1: treating Ethylene Vinyl Acetate (EVA) into particles; step 2: sorting the particles into multiple piles and mixing the piles of particles with color agents to form multiple piles of mixtures from light color to dark color; step 3: putting the multiple piles of mixtures into respective cavities in a dispenser, and step 4: putting the multiples of material into a shoe mold and foaming the material under certain temperature to form a shoe sole.

The primary object of the present invention is to provide a method and device to make an EVA shoe sole that has a gradually changed color.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the device and three piles of material of the present invention;

FIG. 2 is an exploded view to show three piles of material, a dispenser and a shoe mold of the present invention;

FIG. 3 shows a board is pulled from the dispenser to allow the piles of material to be put in the mold;

FIG. 4 shows that the mold with the material filled in the mold is treated;

FIG. 5 shows a shoe sole made by the method of the present invention;

FIG. 6 shows six piles of material, the dispenser and the mold;

FIG. 7 shows a board is pulled from the dispenser to allow the piles of material in FIG. 6 to be put in the mold; and

FIG. 8 shows a shoe sole made by the six piles of material according to the method of the present invention.

### DETAILED DESCRIPTION OF THE PREFERRED EMBODIMENT

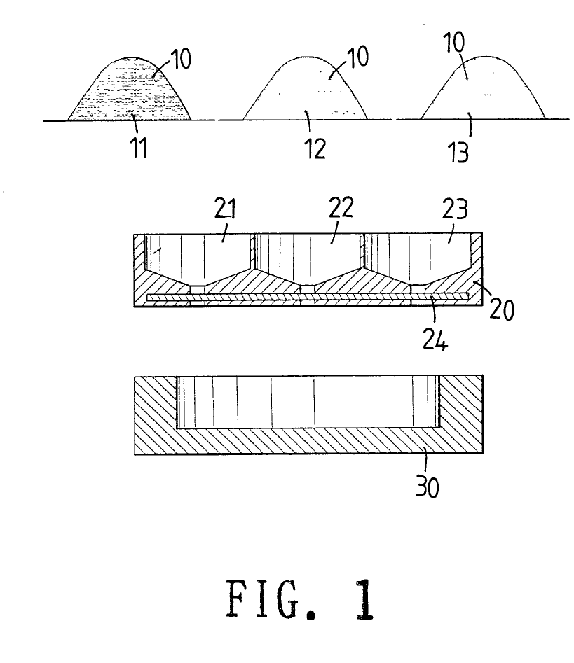

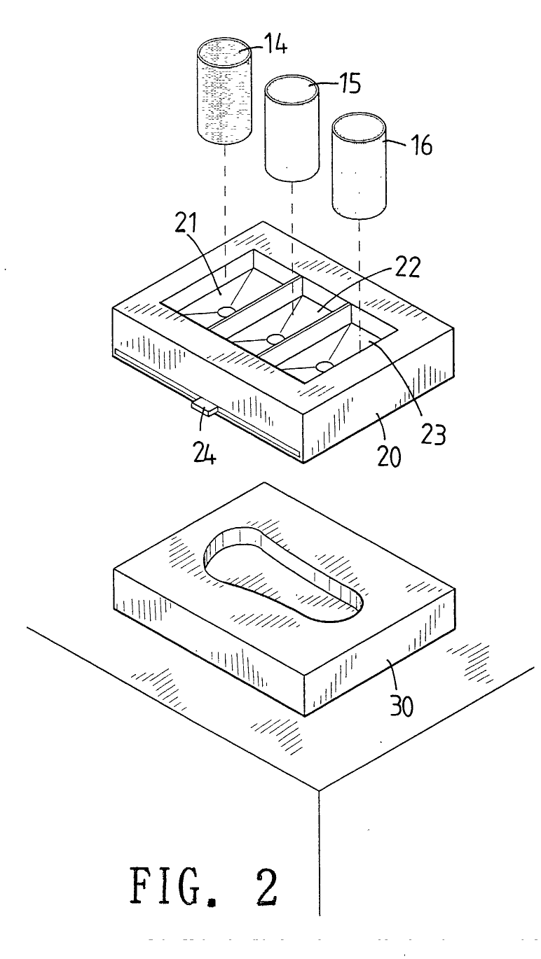

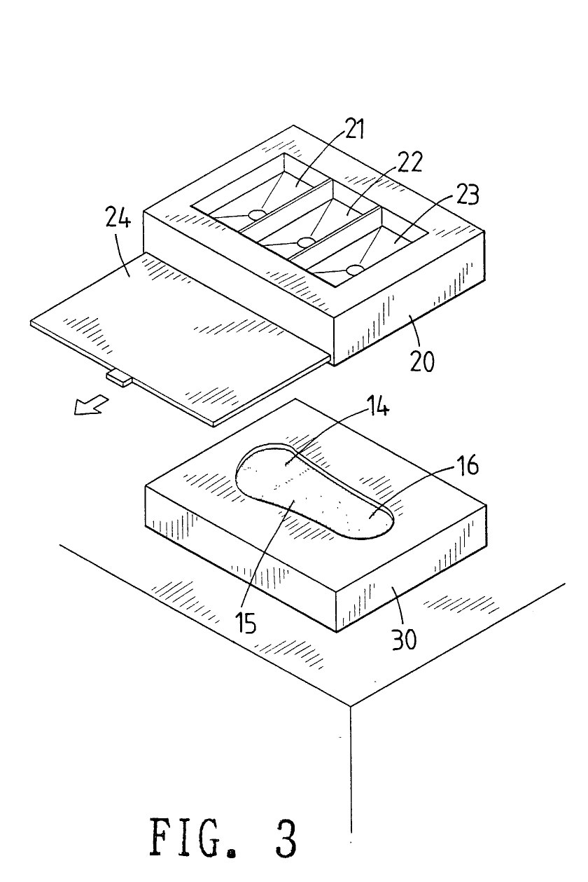

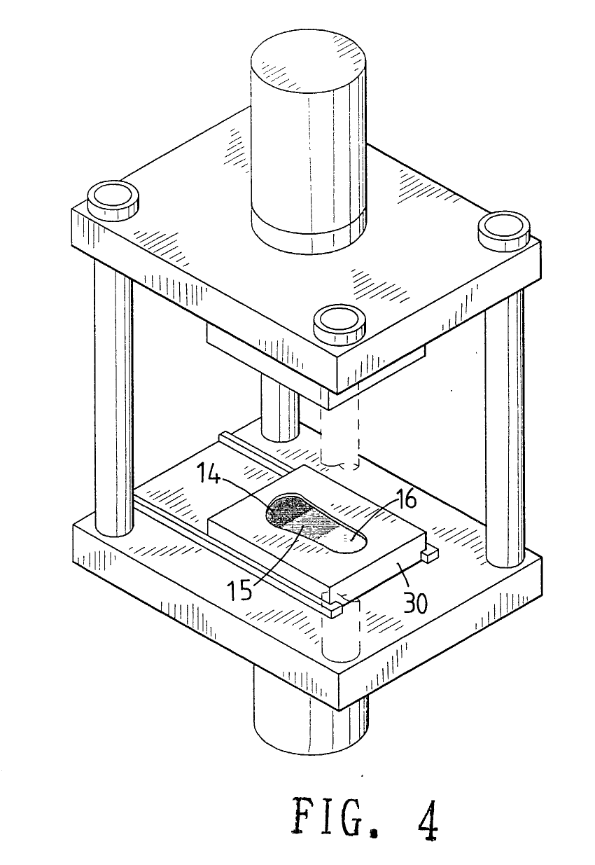

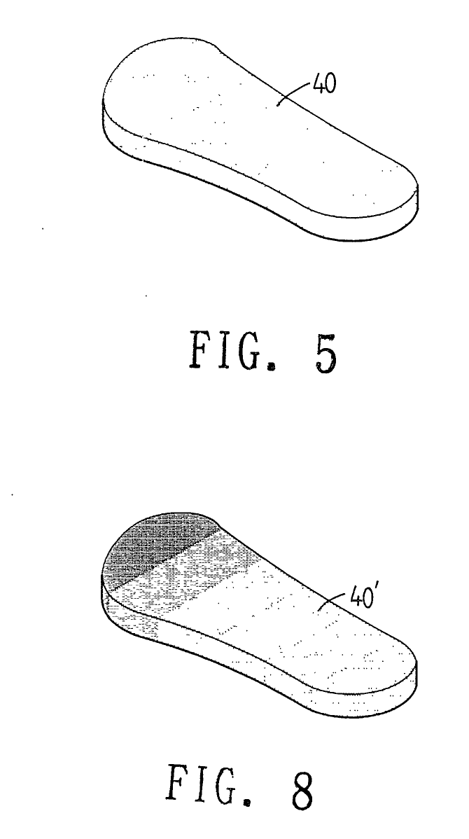

Referring to FIGS. 1 to 5, the method and a device for making a shoe sole of the present invention comprises

step 1: treating Ethylene Vinyl Acetate (EVA) into particles 10;

step 2: sorting the particles into multiple piles and mixing the piles of particles 10 with color agents 11, 12, 13 to form multiple piles of mixtures from light color to dark color;

step 3: preparing the multiple piles of mixtures 14, 15, 16 to be pre-set weight;

step 4: putting the multiple piles of mixtures 14, 15, 16 into respective cavities 21, 22, 23 in a dispenser 20, and

step 5: putting the multiples of material into a shoe mold 30 and foaming the material under certain temperature to form a shoe sole.

A board 24 which is removably inserted in the dispenser 20 in step 3 to seal the cavities 21, 22, 23 of the dispenser 20. When pulling the board 24 out from the dispenser 20, the multiples of the mixtures 14, 15, 16 drop from the cavities 21, 22, 23 in the dispenser 20 and fill in the mold 30. The shoe sole 40 made of the above mentioned method have a gradually changed color which is fadeless.

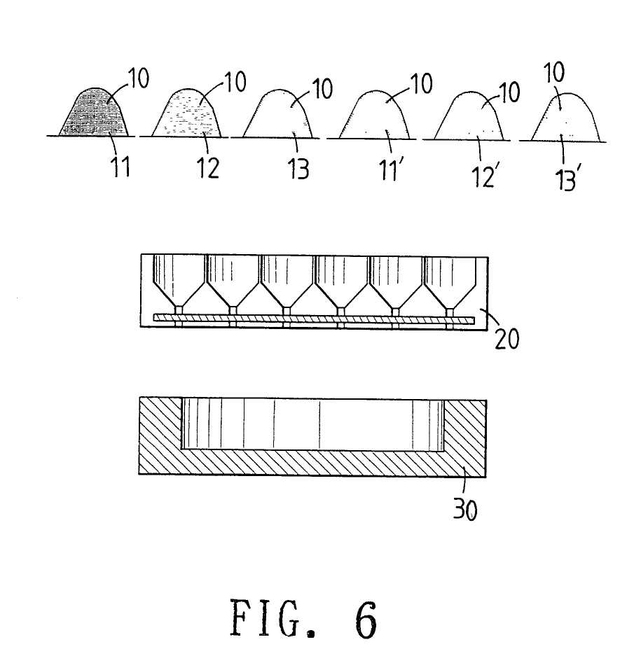

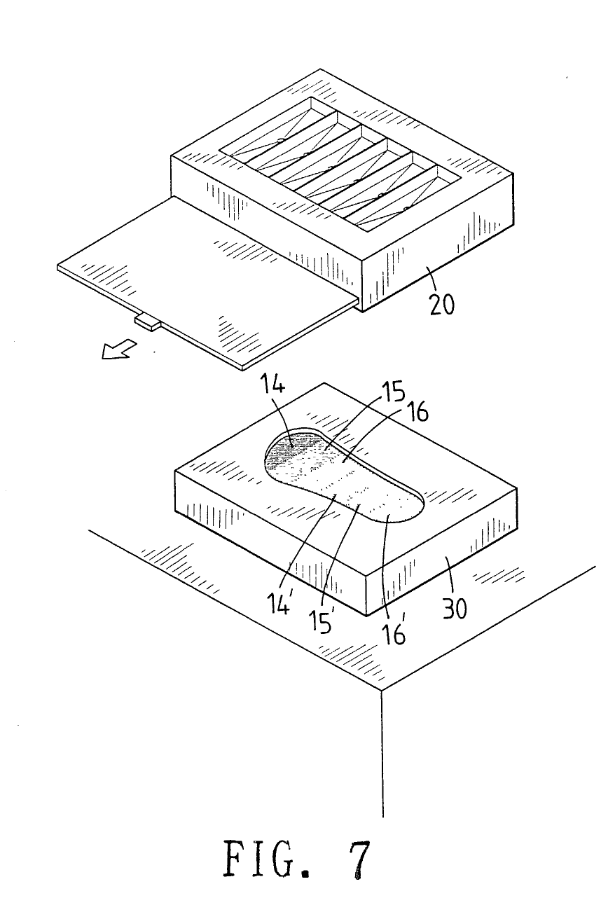

FIGS. 6 to 8 show another embodiment of the method wherein the number of the piles of particles 10 are six and each is mixed with a respective color agent 11/12/13/11′/12′/13′. By this method, the shoe sole 40′ include more levels of colors which may be formed from light to dark gradually.

While we have shown and described the embodiment in accordance with the present invention, it should be clear to those skilled in the art that further embodiments may be made without departing from the scope of the present invention.

What is claimed is:

1. A method and a device for making a shoe sole, comprising:
step 1: treating Ethylene Vinyl Acetate (EVA) into particles;
step 2: sorting the particles into multiple piles and mixing the piles of particles with color agents to form multiple piles of mixtures from light color to dark color; and
step 3: preparing the multiple piles of mixtures to be pre-set weight;
step 4: putting the multiple piles of material having pre-set weight into a shoe mold and foaming the material under certain temperature to form a shoe sole.

2. The method and the device as claimed in claim 1 further comprising a step of putting the multiple piles of mixtures into respective cavities in a dispenser before step 4.

3. The method and the device as claimed in claim 1 further comprising a board 24 which is removably inserted in the dispenser to seal the cavities of the dispenser.
